(19) United States
(12) Patent Application Publication
(10) Pub. No.: US 2014/0007420 A1
(43) Pub. Date: Jan. 9, 2014

(54) TUBE FINNING MACHINE

(71) Applicant: David Bland Pierce, Hatton Park (GB)

(72) Inventor: David Bland Pierce, Hatton Park (GB)

(21) Appl. No.: 13/936,471

(22) Filed: Jul. 8, 2013

(30) Foreign Application Priority Data
Jul. 6, 2012 (GB) 1212048.1

(51) Int. Cl. B23P 15/26

(52) U.S. Cl. CPC B23P 15/26
USPC 29/726

(57) ABSTRACT

This invention relates to a tube finning machine, i.e. to a machine adapted to fit one or more fins onto one or more tubes. The tube finning machine has a base with a primary axis and a mounting part upon which a plurality of tubes can be mounted in a desired array. The tubes are aligned with the primary axis. A carrier locates a number of fins and a drive means, suitably hydraulic, moves the carrier relative to the mounting part in the direction of the primary axis in order to drive the fins onto the tubes. The machine can be adjusted to fit a variable number of fins to a variable array of tubes. The mounting part and the carrier are both movable relative to the base in the direction of the primary axis, and the mounting part is movable relative to the base between a number of predetermined mounting positions. The length of the tubes to which fins can be fitted is therefore also variable, and may for example be up to 12 metres.

### FIELD OF THE INVENTION

This invention relates to a tube finning machine, i.e. to a machine adapted to fit one or more fins onto one or more tubes.

The invention is expected to find its greatest utility in relation to the finning of tubes for use in a heat exchanger, and so the following description will refer primarily to heat exchange applications. The use of the machine for other applications is not thereby excluded.

### BACKGROUND OF THE INVENTION

Often it is necessary to cool a working fluid, and it is known for this purpose to use a heat exchanger. Heat exchangers are made in many different sizes, are used with many different working fluids, and utilise many different fluids as the coolant. The present invention is directed primarily at heat exchangers in which the working fluid is a liquid, typically water, and in which the coolant is a gas, typically air. Such heat exchangers are widely used on industrial compressors for example, but the invention is also expected to have utility for other air-cooled heat exchangers.

A particular type of heat exchanger for which the invention is suitable is the class of heat exchangers known as “fin fan” heat exchangers. Such heat exchangers are widely used in the petrochemical industry in particular, and comprise tubes of up to 12 metres long, the tubes being fitted with closely-spaced fins. In use, air is blown across the fins, the heat exchanger typically being used to condense steam within the tubes.

As the working fluid flows along the tubes of a heat exchanger it gives up latent heat to the tubes and fins and in turn to the coolant flowing between the fins and around the tubes. The fins increase the available surface area for heat transfer, but also cause an increase in the pressure drop as the coolant passes between and around the tubes. The pressure drop is usually not significant in heat exchangers in which the coolant is air, but the heat exchanger designer will nevertheless typically seek to increase the density of the fins so as to increase the heat exchange, without exceeding a maximum permissible pressure drop.

The working fluid in fin fan heat exchangers in particular is usually under high pressure. It is therefore a typical requirement that the tubes must be continuous, i.e. it is not permissible to fabricate a heat exchanger by joining tubes end-to-end because of the likelihood of leaks at the pressures involved. The tube finning machine for making fin fan heat exchanger tubes must therefore be able to add fins to tubes up to around 12 metres long. Similar length heat exchanger tubes are also used in some industrial compressors.

### DESCRIPTION OF THE PRIOR ART

Heat exchangers are most often constructed from metallic materials, i.e. metallic fins fitted to metallic tubes. Metals are commonly used because of their good thermal transfer properties. To secure a fin to the tube it is known to provide an aperture in the fin and to weld or braze the fin onto the tube. This method of manufacture suffers from several significant disadvantages. Firstly, the materials which can be used for the tubes and the fins are limited to those which can be welded or brazed. Secondly, the form of the materials used, such as for example the minimum wall thickness of the tube, is determined by the requirement to withstand the welding or brazing operation (so that a relatively thick tube may need to be used, whereas a thinner tube would enhance the heat exchange performance). Thirdly, the welding or brazing operation raises the temperature of the tubes and fins sufficiently to heat treat the materials, the final product being softer than the starting materials—the starting materials must therefore be chosen so that the final product meets the desired material requirements. Fourthly, the requirement for a welding or brazing operation adds time and cost to the manufacture of the heat exchanger.

In an alternative known method of manufacture the fins are initially located as a loose fit upon the tubes and the tubes are thereafter mechanically expanded by a specialised expanding machine into thermal engagement with the fins. This method of manufacture also has a number of significant disadvantages. The first disadvantage is shared with the first method stated above, namely that the material of the tube in particular is limited to those which can be mechanically expanded. The second disadvantage is also shared with the first method as stated above, namely that the minimum thickness of the tubes is determined by the requirement for expansion—very thin tubes, which might be particularly suitable for heat exchangers, cannot be used if there is a possibility that they would split during the expansion process, or be sufficiently weakened by the expansion process to fail in service. The third disadvantage is that the fins are sometimes pushed along the tubes during the expansion process, so that the resulting fin spacing or density is not always consistent along the length of the tubes—this can have a significant effect upon both the heat exchanger performance and the pressure drop of the coolant.

WO96/35093 discloses a tube finning machine and method in which fins can be pressed onto tubes by a linear motor, the tubes and fitted fins together comprising a “fin block”. A desired number of fin blocks can be fitted to header tanks in a subsequent step of manufacturing a heat exchanger. The linear motor has the accuracy required to ensure that the fins are accurately and consistently spaced. Since no welding or brazing is required, and no expansion of the tube is required, the materials of the tubes and/or fins is less limited than the earlier-described methods, and the machine and method can be used with a mixture of different materials for the tubes and/or fins in a single heat exchanger block.

The apertures in the fins described in WO96/35093 are closely-sized to match the outside diameter of the tubes. The apertures in many embodiments are formed with collars which engage the tubes in use and enhance the heat exchange performance. Whilst it is primarily intended that the linear motor will determine the position of each of the fins, it is often desired that the collar of one fin engages the collar of the adjacent fin, and it is disclosed that in some heat exchangers the fin spacing can be determined by the engagement of adjacent fins. Since the fin spacing is usually predetermined by the heat exchange and pressure drop required, in such embodiments the length of the collars is designed to provide the desired fin spacing.

Another tube finning machine for manufacturing fin blocks is disclosed in WO02/30591. That document discloses the use of a cartridge mechanism into which a large number of fins can be loaded, and which can thereafter be pressed onto the tubes together. This machine and method can provide a considerable reduction in the time taken, and therefore the manufacturing cost of, certain fin blocks.

### DISCLOSURE OF THE INVENTION

The present invention seeks to provide an improved tube finning machine which is particularly suitable for use in making fin blocks having long tubes, such as those used in fin fan heat exchangers and larger industrial compressors. The machine is nevertheless readily adaptable to make fin blocks with shorter tubes.

According to the invention there is provided a tube finning machine having:

a base;

a mounting part upon which a plurality of tubes can be mounted;

a carrier upon which a number of fins can be located;

drive means for moving the carrier relative to the mounting part;

characterised in that the mounting part and the carrier are both independently movable relative to the base;

and in that the mounting part is movable relative to the base between a number of predetermined mounting positions.

The predetermined mounting positions are provided to accommodate tubes of differing lengths. Thus, whilst the base may be sufficiently long to accommodate tubes of up to six metres for example, it is desirable to reduce the distance through which the carrier must move dependent upon the length of the tubes. Thus, if the machine is being used to apply fins to tubes which are two metres long, the mounting part can be moved relative to the base so that the carrier is only required to move slightly more than two metres as the initial fins are applied (and successively smaller distances as the fins are applied to the tubes).

Preferably, the carrier has a support plate adapted to support the fins before they are mounted on the tubes, the support plate being movable in a substantially vertical direction. The support plate can therefore provide a tray or platform upon which the fins can be located prior to fitment onto the tubes, the support plate being movable downwardly after the fins have been pushed onto the ends of the tubes (and are supported by the tubes) so as to avoid fouling of the mounting part during subsequent movement of the fins along the tubes. Thus, it will be understood that the fins are only required to be supported by the support plate before they are supported by the tubes; once the fins are supported by the tubes the support plate can be moved away.

Desirably, the support plate carries a guide plate, the guide plate having a number of recesses corresponding to the number and disposition of the tubes. The guide plate serves to support the tubes before they engage the fins, and also serves to guide the tubes into alignment with the apertures in the fins.

Preferably, the guide plate is movably mounted upon the support plate. The guide plate can thereby serve the additional function of determining the number of fins to be pushed onto the tubes during each cycle of operation of the carrier, the position of the guide plate upon the support plate determining the space within which the fins can be located, and thereby the number of fins which can be located upon the support plate.

Ideally, the fins have integral spacers. Suitable fins for use with the present machine are disclosed in our copending applications PCT/GB2011/052054 and PCT/GB2012/050271. Since the effective thickness of each fin and its integral spacers is known, the number of fins can be determined by adjusting the guide plate to a position equal to a desired multiple of the effective fin thickness.

Desirably, the mounting part includes a mounting frame and a tube connector. The tube connector is preferably mounted upon a plurality of connector arms which are movably mounted upon the mounting frame. In this way, further adjustment of the position of the tubes relative to the carrier can be made, so that the machine can readily be adjusted to match the length of the tubes. The connecting arms are preferably mounted upon the mounting frame in one of a number of discrete positions. Preferably also, the connecting arms project towards the carrier.

Preferably, the drive means is a hydraulic cylinder and piston arrangement incorporating a position feedback system. Ideally, the position feedback system comprises a micropulse transducer located within the cylinder and responsive to the position of the piston, the micropulse transducer providing a linear feedback measurement corresponding to the piston position. The drive means preferably includes a servo controlled hydraulic valve. Such a drive means can provide positional accuracy of +/− 0.05 mm. A single hydraulic cylinder and piston can readily provide a force of 10-15 tonnes which is expected to be sufficient to push a number of fins into a desired position upon a number of tubes. The servo controlled hydraulic valve is preferably controlled by a PLC, whereby multiple sequential or concurrent automated machine operations can be effected together.

Desirably, the mounting frame of the mounting part straddles the hydraulic cylinder and piston. Whilst the mounting part does not move whilst the machine is applying fins to the tubes, it is necessary that the mounting part can move relative to the hydraulic cylinder and piston during adjustment of the position of the mounting part.

### BRIEF DESCRIPTION OF THE DRAWINGS

The invention will be further described, by way of example, with reference to the accompanying drawings, in which:

FIG. 1 shows a side view of the machine at the first stage of the tube finning process;

FIG. 2 shows a plan view of the machine at the first stage;

FIG. 3 shows a side view of the machine at the second stage of the tube fining process;

FIG. 4 shows a side view of the machine at the third stage of the tube fining process; and

FIG. 5 shows a perspective view of part of the machine.

### DESCRIPTION OF THE EXEMPLARY EMBODIMENT

The machine 10 comprises a substantially rigid base 12 upon which the other componentry is mounted. A mounting part 14 is adapted to be secured in a chosen position upon the base 12, the chosen position being one of several possible positions along the base, dependent upon the length of the tubes 16 to which the fins 18 (FIGS. 2,5) are to be fitted.

In this embodiment, the base 12 has two rails 20 (FIGS. 2,5), the mounting part 14 being mounted upon the rails by way of suitable bearings (not shown). The mounting part 14 can therefore be moved along the base 12 to a chosen position, and locked in the chosen position (suitably by one or more pegs locating into one or more of the series of bolt holes 22 in the rails 20). Whilst the mounting part 14 is therefore movable relative to the base 12, it is not desired that the mounting part be moved during the tube finning process. Instead, the movement is to permit suitable adjustment of the position of the mounting part prior to the finning process, appropriate to the length of the tubes 16.

A plurality of tubes 16 (in this embodiment six tubes 16) are rigidly mounted to the mounting part 14 by way of the tube connector 46 (FIGS. 2,5). The tube connector 46 can be of many different designs suitable for mounting the tubes 16, including for example two bars with aligned substantially semi-circular recesses, the bars being clamped together whereby the end of a tube is correspondingly clamped within the respective recesses.

A movable carrier 24 is mounted upon the rails 20, again by suitable bearings (not shown), and is connected to one end of the drive piston 26, the other end of which piston is located within hydraulic drive cylinder 28 which is rigidly secured to the base 12. Though not shown in the figures, the drive cylinder 28 is connected to a hydraulic power pack by way of hydraulic hoses, whereby hydraulic fluid can be pumped into the cylinder 28, and pumped out of the cylinder 28, whereby to extend and retract the piston 26 and move the carrier 24 along the base 12.

The carrier 24 has a support plate 30 upon which the fins 18 are placed prior to fitment onto the tubes 16. A guide plate 32 is mounted on the support plate 30. The guide plate 32 has a number of open-topped recesses 34 which are substantially part-circular, and which serve to align the tubes 16 with the apertures in the fins 18. It will be seen that the guide plate 32 has sixteen recesses 34, and so can accommodate up to sixteen tubes, notwithstanding that only six tubes are shown in this embodiment.

The carrier 24 also has a back plate 36, which has apertures corresponding to the apertures in the fins, and through which respective tubes 16 can pass. Whilst the apertures are not shown in the drawings, it will be understood that there are sixteen apertures corresponding to the sixteen recesses of the guide plate 32, so that the machine 10 is suitable for making a fin block having up to sixteen tubes.

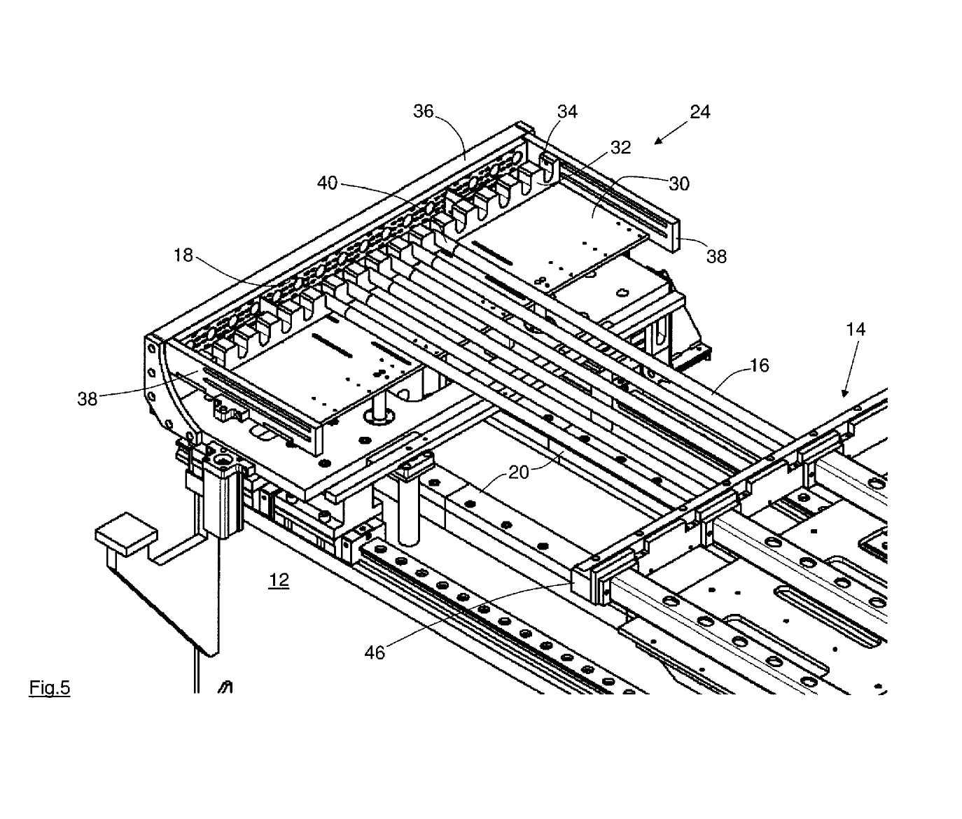

A batch of fins 18 is located upon the support plate 30, between the back plate 36 and the guide plate 32. The fins 18 are not shown individually in FIG. 2, but are instead represented as a single block (FIG. 5 shows a single fin for clarity). It will be understood, however, that a chosen number of fins is located upon the support plate 30, each fin ideally having integral spacer means whereby the fins are separated by a predetermined distance.

The guide plate 32 can be mounted upon the support plate 30 in a chosen position, the position determining the separation S between the back plate 36 and the guide plate 32, the separation S being a desired multiple of the effective thickness of the fins 18. In this way, the position of the guide plate 32 determines the number of fins 18 which can be positioned upon the carrier 24, and which are pushed onto the fins during each cycle of operation.

If the fins with which the machine is to be used have a standard form, and in particular a standard thickness, and spacers of a standard height, the guide plate may have a number of discrete and predetermined positions. In most embodiments, however, the position of the guide plate is infinitely variable relative to the support plate 30, so as to cater for fins of varying thickness and having spacers of varying height.

It will also be understood that the guide plate 32 is positioned so as to provide sufficient room to locate the required number of fins. Thus, it is not necessary (or even preferable) that the fins 18 are tightly held between the back plate 36 and the guide plate 32, and it is only necessary that the fins 18 are maintained upright so that their apertures are aligned and accessible to the tubes 16.

It will be seen from FIG. 2 in particular that the carrier 24 can accommodate a significantly greater number of fins 18 than in the present embodiment, i.e. the separation S between the back plate 36 and the guide plate 32 is only a small proportion of the available length L of the support plate 30. The carrier 24 can therefore be adjusted to accommodate a large range in the number of fins 18.

It will also be seen from FIGS. 2 and 5 that the support plate 30 also mounts two end stops 38 which serve to limit the transverse movement of the fins 18, and therefore help to align the apertures in the fins 18 with the tubes 16.

It will be understood that the tubes 16 are mounted in cantilever, and are therefore liable to bend. The centralising cones (or bullets) 40 (FIGS. 4,5) fitted into the free ends of the tubes 16 may therefore need to be lifted into alignment with the apertures in the fins 18. The centralising cones 40 have a tapered leading end which can engage the guide plate 32 (and in an alternative embodiment the guide plate 32 can have a tapering bottom edge to each of the recesses 34) so that as the centralising cones 40 enter the respective recesses 34 the tubes 16 are lifted as required. However, as explained below, in the present embodiment the tapered leading end of the centralising cones is required only to lift the tubes during the initial adjustment of the machine, i.e. prior to fitment of any fins.

The mounting part 14 comprises a mounting frame 42 to which is secured four connector arms 44. The tube connecter 46 to which the ends of the tubes 16 are secured is securely fixed to one end of each of the connector arms 44. The connector arms 44 are each secured to the mounting frame 42 by a number of bolts fitted through respective bolt holes 50. It will be seen that the array of bolt holes 50 for each connector arm 44 extends beyond the mounting frame 42, whereby to provide a large number of discrete mounting positions for the arms 44. In this way, the position of the connector arms 44, and in particular the position of the tube connector 46, can be adjusted relative to the mounting frame 42 whereby to suit different tube lengths.

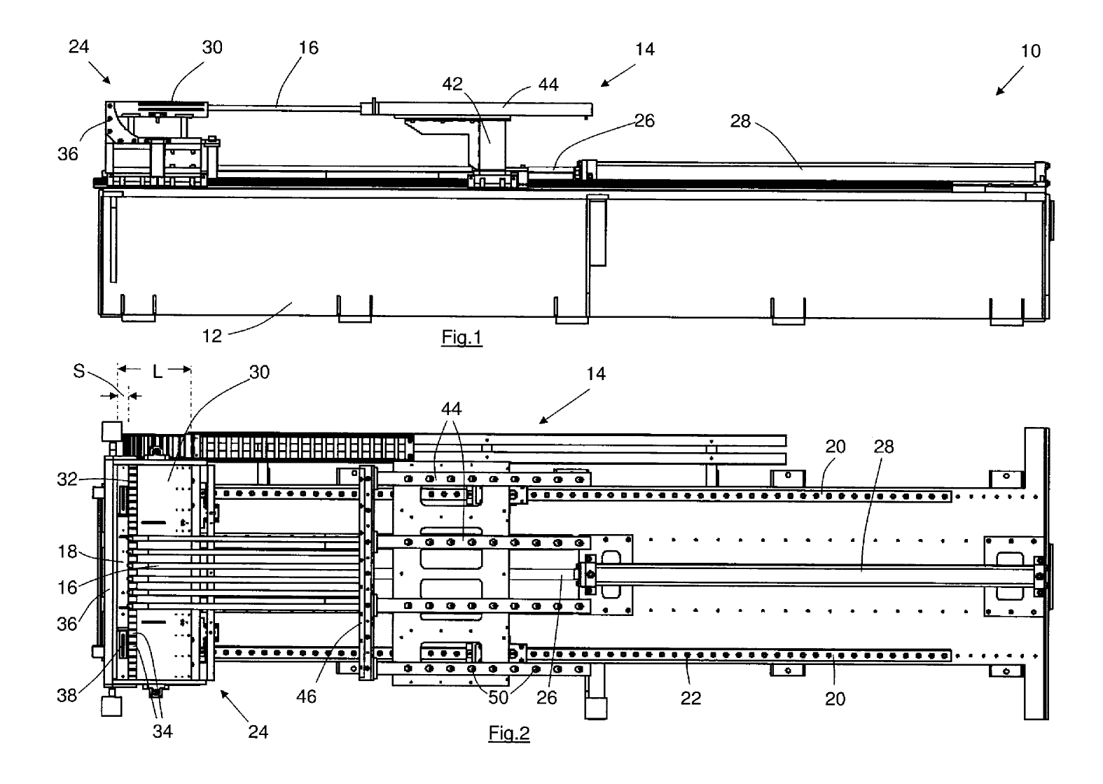

FIGS. 1 and 2 show the first stage of a tube finning process. It will be understood that a preliminary or setting up stage is required during which the machine 10 is adjusted to manufacture a fin block comprising a chosen number of fins upon a chosen number and length of tubes.

The following procedures are involved in setting up the machine 10 (in no particular order). The connector arms 44 are moved (if adjustment is necessary) to their chosen position relative to the mounting frame 42. The mounting part 14 is moved (if adjustment is necessary) to its chosen position along the base 12. The guide plate 32 and stops 38 are moved (if adjustment is necessary) to their chosen positions upon the support plate 30. Thereafter, the ends of the chosen number of tubes 18 are secured to the tube connector 46, and the appropriate number of fins 18 are placed between the back plate 36 and the guide plate 32.

It will be seen from FIG. 2 that the machine is set up so that, for the particular length of tubes 16, the position of the mounting part 14 upon the base 12, and the position of the connector arms 44 upon the mounting frame 42, are adjusted so that the centralising cones 40 lie within the respective recesses 34 of the guide plate 32 when the piston 26 is at its most extended position as shown in FIGS. 1 and 2.

Since the apertures in the fins 18 are aligned with the recesses 34 in the guide plate 32, the centralising cones 40 are aligned with the apertures in the fins 18.

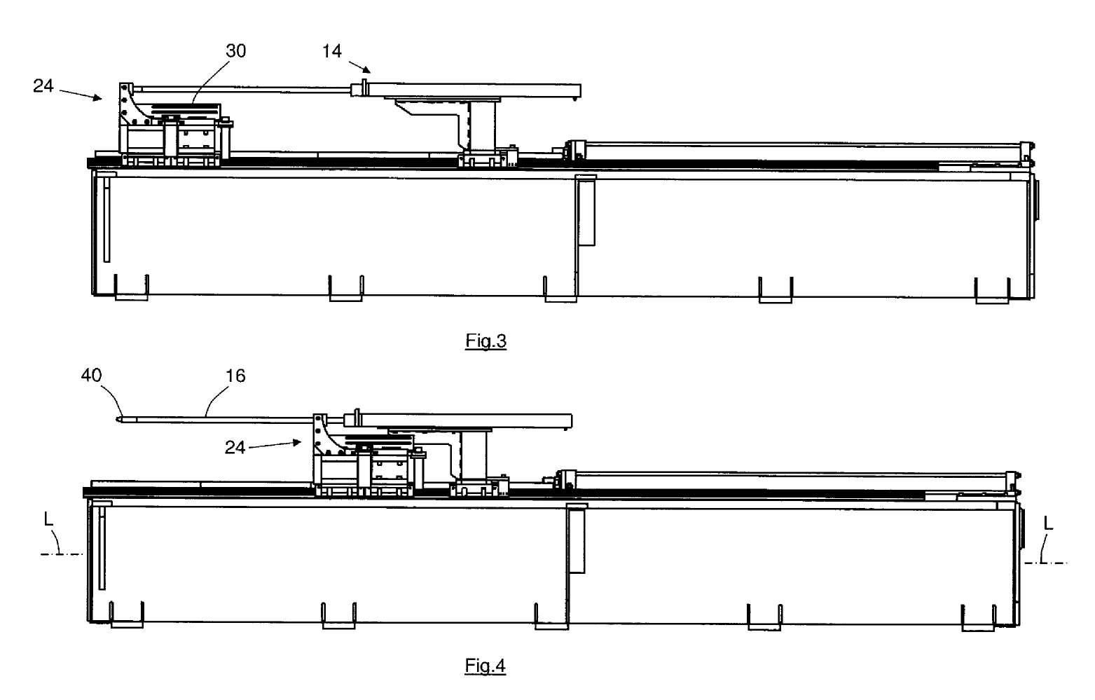

FIG. 3 shows the second stage of the tube finning process. The hydraulic drive has been actuated to drive the carrier 24 a small distance to the right as drawn, the distance corresponding to slightly more than the spacing S between the guide plate 32 and the back plate 36. Accordingly, during this movement the centralising cones 40 pass through the apertures in the fins 18, and into the aligned apertures in the back plate 36.

The fins 18 are thereby supported by the tubes 16, and the ends of the tubes are supported by the back plate 36. The support plate 30 can therefore be lowered to the position of FIG. 3, specifically to avoid fouling of the mounting part 14 during the subsequent operational steps. Though not seen in FIG. 3, it will be understood that the back plate 36 (which does not move downwardly with the support plate 30) has engaged the rearmost fin 18 and, by way of their respective spacers, the fins 18 have been pressed together onto the centralising cones 40.

In this embodiment the support plate 30 is lowered (and subsequently raised) by a hydraulic drive, preferably including an auxiliary hydraulic pump which operates alongside the main hydraulic pump serving the cylinder 28. In other embodiments the support plate is lowered and raised by other means, such as mechanically, electrically or pneumatically, for example.

When the support plate 30 has been lowered sufficiently to avoid fouling the mounting part 14, the hydraulic drive is further actuated whereby to drive the piston 26 and carrier 24 to the right, to the position shown in FIG. 4. By virtue of the position feedback system of the piston and cylinder arrangement, the carrier 24 drives the fins 18 to a predetermined position along the tubes 16, the predetermined position depending upon the requirements of the heat exchanger designer, and the presence (or otherwise) of previously fitted fins.

Following the third stage of the finning process as seen in FIG. 4, the carrier 34 is driven back to the left, to its position of FIG. 3. The support plate 30 is lifted to the position of FIG. 1 before the carrier is driven back to the position of FIGS. 1 and 2.

The fact that the support plate 30 is lifted whilst the carrier is in the position of FIG. 3 is a valuable optional feature, since in that position the centralising cones 40 are located within the apertures of the back plate 36. The ends of the tubes are thereby supported and any tendency of the tubes to bend downwardly (as may occur with very long tubes is fitted with a large number of fins) is resisted. The support plate 30 is raised, whereupon the ends of the tubes 18 lie within the recesses 34 of the guide plate 32, before the carrier moves to the position of FIG. 1. In that position, the centralising cones are located within the recesses 34 and the ends of the tubes are supported by the guide plate 32.

The advantage of the adjustability of the machine is therefore apparent, i.e. the adjustability of the mounting part 14 relative to the base 12, and the adjustability of the connector arms 44 relative to the mounting frame 42, permit the ends of the tubes 18 to be continuously supported by the guide plate 32 and the back plate 36 for any length of the tubes 18 (within the limit set by the overall length of the machine). It will be understood that the tubes 18 can be continuously supported, regardless of their length, as long as the distance between the respective adjustment positions is no greater than the thickness of the guide plate 32. This can readily be ensured by way of the combination of adjustment provided firstly by the mounting frame 42 along the rails 20, and secondly by the connector arms 44 along the mounting frame. The available adjustment positions can be supplemented if desired by the provision of different-length centralising cones 40.

In an alternative but less preferred machine sequence, the carrier 24 is moved to the position of FIG. 1 before the support plate 30 is raised. Even if the unsupported tubes bend downwardly as they move out of the apertures in the back plate 36, the ends of the tubes will be subsequently lifted by the guide plate as the support plate 30 is raised.

It will be understood that the machine cycle of the first, second and third stages can be s repeated whereby subsequent batches of fins 18 are pressed onto the tubes, until the desired number of fins has been fitted and the fin block completed.

Ideally, the stroke of the piston and cylinder arrangement for a large machine 10 is around six metres. This permits the finning of fins to tubes up to around twelve metres long (fins being applied to one end of the tubes, before the tubes are turned around and fins are applied to the other end). Smaller (or larger) machines can, however, be provided, as desired.

As above indicated, the machine cycle is preferably automated and controlled by PLC, the PLC being set up with predetermined machine cycles for particular fin blocks. The machine will preferably include a control panel allowing the operator to determine certain parameters, such as the speed at which the carrier 24 is moved during the various stages of the cycle, as well as the acceleration and deceleration of the carrier, for example. Also, the machine may allow for operator control if desired, i.e. the operator can override the automated machine cycle and control the position of the carrier 24 directly. The latter option may utilise proportional velocity control for the carrier so that the operator can effect precise movements of the carrier.

The direction of movement of the piston 26 is defined herein as the primary axis of the machine 10. The tubes 16 are aligned with the primary axis. The rails 20 and the connector arms 44 are also aligned with the primary axis so that the adjustment of the position of the mounting part, and in particular the position of the tube connector 46, is along the primary axis. Also, the movement of the guide plate 32 relative to the support plate 30 is in the direction of the primary axis. In the embodiment shown the primary axis is parallel to the longitudinal axis L-L of the base 10.

During use of the embodiment shown the tubes are held in position and the fins are moved therealong. It will be appreciated, however, that alternative embodiments are possible in which the fins are held in position are the tubes are moved therethrough. In such embodiments the carrier will be discretely adjustable in the direction of the primary axis and the drive means will move the mounting part.

1. A tube finning machine having:
a base, the base having a primary axis;
a mounting part upon which a plurality of tubes can be mounted in a desired array, the tubes being aligned with the primary axis;
a carrier upon which a number of fins can be located;
drive means for moving the carrier relative to the mounting part in the direction of the primary axis;
characterised in that the mounting part and the carrier are both movable relative to the base in the direction of the primary axis;
and in that the mounting part is movable relative to the base between a number of predetermined mounting positions.

2. The tube finning machine according to claim 1 in which the carrier has a support plate for the fins.

3. The tube finning machine according to claim 2 in which the support plate is movable relative to the base in a direction which is substantially perpendicular to the primary axis.

4. The tube finning machine according to claim 2 in which the support plate carries a guide plate, the guide plate having a number of recesses corresponding to the desired array.

5. The tube finning machine according to claim 4 in which the guide plate is movable relative to the support plate in the direction of the primary axis.

6. The tube finning machine according to claim 1 in which the mounting part includes a mounting frame and a tube connector.

7. The tube finning machine according to claim 6 in which the tube connector is mounted upon at least one connector arm.

8. The tube finning machine according to claim 7 in which the at least one connector arm is mounted upon the mounting frame, and in which the at least one connector arm is movable relative to the mounting frame in the direction of the primary axis.

9. The tube finning machine according to claim 8 in which the position of the at least one connecting arm upon the mounting frame is adjustable between a number of discrete positions.

10. The tube finning machine according to claim 7 in which the at least one connecting arm projects from the mounting frame towards the carrier.

11. The tube finning machine according to claim 1 in which the drive means is a hydraulic cylinder and piston arrangement incorporating a position feedback system.

12. The tube finning machine according to claim 11 in which the position feedback system comprises a micropulse transducer located within the cylinder and responsive to the position of the piston, the micropulse transducer providing a linear feedback measurement corresponding to the piston position.

13. The tube finning machine according to claim 11 in which the drive means includes a servo controlled hydraulic valve.

14. The tube finning machine according to claim 11 in which the mounting part straddles the hydraulic cylinder and piston.
